(19) United States
(12) Patent Application Publication
(10) Pub. No.: US 2024/0053540 A1
(43) Pub. Date: Feb. 15, 2024

(54) LIGHT GUIDE PLATE AND MANUFACTURING METHOD OF THE SAME

(71) Applicant: AGC Inc., Tokyo (JP)

(72) Inventors: Makoto MATSUI, Shizuoka (JP); Kunihisa TAKAHASHI, Shizuoka (JP)

(73) Assignee: AGC Inc., Tokyo (JP)

(21) Appl. No.: 18/383,030

(22) Filed: Oct. 23, 2023

Related U.S. Application Data
(63) Continuation of application No. PCT/JP2022/018125, filed on Apr. 19, 2022.

(30) Foreign Application Priority Data
Apr. 30, 2021 (JP) 2021-077465

(51) Int. Cl. G02B 6/122; G02B 6/13

(52) U.S. Cl. CPC G02B 6/122; G02B 6/13

(57) ABSTRACT

A light guide plate includes a glass substrate having a mark on a surface thereof and a refractive index of 1.7 or more. The mark includes a plurality of dots. Each dot is contained in a minimum circle having a diameter of 30 to 250 μm. Each dot has raised portions higher than the surface at outermost and innermost peripheral edge portions having a height of 0.11 to 4 μm. Each dot is composed of laser irradiation marks, each having a diameter of 10 to 40 μm, and being in contact with or overlapping with each other. A specific loop shape, formed by the laser irradiation marks, having a diameter of a minimum circle containing the loop shape of 100 μm or less, is configured as an open loop including an open portion having a length of one tenth to twice of a maximum diameter of the laser irradiation mark.

### CROSS-REFERENCE TO RELATED APPLICATION

The present application is a continuation application of International Application No. PCT/JP2022/018125, filed Apr. 19, 2022, which claims priority to Japanese Patent Application No. 2021-077465 filed Apr. 30, 2021. The contents of these applications are incorporated herein by reference in their entirety.

### BACKGROUND OF THE INVENTION

### 1. Field of the Invention

The disclosure herein generally relates to a light guide plate and a method of manufacturing the light guide plate.

### 2. Description of the Related Art

In recent years, wearable devices that enable virtual reality (VR), augmented reality (AR), and mixed reality (MR) have attracted attention. A light guide plate made of high refractive index glass is often used in such wearable devices.

In such a light guide plate, it is considered preferable to form a mark such as an identifier on the surface of the light guide plate in order to facilitate identification and management. As a method of forming such a mark, it is conceivable to apply a laser marking technique as described in WO 2018/150759.

### SUMMARY OF THE INVENTION

### Problems to be Solved by the Invention

In the light guide plate, in order to facilitate identification and management, it is important to enhance visibility of the mark. Further, in order to form a mark having good visibility, it is considered to be effective to irradiate a high refractive index glass with a high output laser beam.

However, in experiments conducted by the inventors of the present invention, it has been found that when the output of the laser beam irradiated to the high refractive index glass is increased, cracks are often generated in the high refractive index glass.

As described above, it is not easy to achieve both the improvement of the visibility of the mark and the suppression of the crack generation.

The present invention has been made in view of such a background, and an object of the present invention is to provide a light guide plate which has a mark with good visibility and in which generation of cracks is significantly suppressed. Another object of the present invention is to provide a method of manufacturing such a light guide plate.

### Means for Solving the Problem

According to an aspect of the present disclosure, a light guide plate includes a glass substrate having a mark on a surface thereof. A refractive index of the glass substrate is greater than or equal to 1.7. The mark is an identifier, an alignment mark, or a combination thereof. The mark includes a plurality of dots. Each of the dots is contained in a minimum circle having a diameter within a range of 30 μm to 250 μm. Each of the dots has a raised portion higher than the surface of the glass substrate, the raised portion being at an outermost peripheral edge portion and at an innermost peripheral edge portion. In a cross section orthogonal to the surface, a height from a deepest portion of each of the dots to a highest position of the raised portion is from 0.11 μm to 4 μm. Each of the dots is composed of an aggregate of laser irradiation marks, each having a diameter of 10 μm to 40 μm, the laser irradiation marks being in contact with or overlapping with adjacent laser irradiation marks. The laser irradiation marks form at least one loop shape. A specific loop shape, which is a loop shape of the at least one loop shape having a diameter of a minimum circle containing the loop shape of less than or equal to 100 μm, is configured as an open loop including an open portion, a length of the open portion being greater than or equal to one tenth of a maximum diameter of the laser irradiation mark and less than or equal to twice the maximum diameter.

According to another aspect of the present disclosure, a method of manufacturing a light guide plate includes forming a mark by irradiating a surface of a glass substrate having a refractive index of greater than or equal to 1.7 with laser light. The laser light has a wavelength in a range of 150 nm to 370 nm. The mark is an identifier, an alignment mark, or a combination thereof. The mark includes a plurality of dots. Each of the dots contained in a minimum circle having a diameter within a range of 30 μm to 250 μm. Each of the dots has a raised portion higher than the surface of the glass substrate, the raised portion being at an outermost peripheral edge portion and at an innermost peripheral edge portion. In a cross section orthogonal to the surface, a height from a deepest portion of each of the dots to a highest position of the raised portion is from 0.11 μm to 4 μm. Each of the dots is composed of an aggregate of laser irradiation marks, each having a diameter of 10 μm to 40 μm, the laser irradiation marks being in contact with or overlapping with adjacent laser irradiation marks. The laser irradiation marks form at least one loop shape. A specific loop shape, which is a loop shape of the at least one loop shape having a diameter of a minimum circle containing the loop shape of less than or equal to 100 μm, is configured as an open loop including an open portion, a length of the open portion being greater than or equal to one tenth of a maximum diameter of the laser irradiation mark and less than or equal to twice the maximum diameter.

According to yet another aspect of the present disclosure, a light guide plate includes a glass substrate having a mark on a surface thereof. A refractive index of the glass substrate is greater than or equal to 1.7. The mark is an identifier, an alignment mark, or a combination thereof. The mark includes a plurality of dots. Each of the dots is contained in a minimum circle having a diameter within a range of 30 μm to 250 μm. Each of the dots has a raised portion higher than the surface of the glass substrate, the raised portion being at an outermost peripheral edge portion and at an innermost peripheral edge portion. In a cross section orthogonal to the surface, a height from a deepest portion of each of the dots to a highest position of the raised portion is from 0.11 μm to 4 μm. Each of the dots is composed of an aggregate of laser irradiation marks, each having a diameter of 10 μm to 40 μm, the laser irradiation marks being in contact with or overlapping with adjacent laser irradiation marks. The laser irradiation marks form at least one loop shape. A specific loop shape, which is a loop shape of the at least one loop shape having a diameter of a minimum circle containing the loop shape of less than or equal to 100 μm, is configured as a closed loop. Sets of the laser irradiation marks adjacent to each other include first to n-th sets, an integer n being greater than or equal to 10, and T being a distance between centers of the adjacent laser irradiation marks in each set. The sets of the laser irradiation marks adjacent to each other include average sets and one or more specific sets. In each of the average sets, a difference between the distance T and a distance Tₐᵥₑ, which is an average of the distances T in the average sets, is within a range of ±1% of the distance Tₐᵥₑ. In each of the one or more specific sets, a difference between the distance T and the distance Tₐᵥₑ is outside the range of ±1% of the distance Tₐᵥₑ. The average sets are, in number, greater than or equal to 90% of all the sets. A distance Tₚ between centers of the adjacent laser irradiation marks in each of the one or more specific sets is greater than the distance Tₐᵥₑ by one tenth of a maximum diameter of the laser irradiation mark.

### Effects of the Invention

According to the present invention, it is possible to provide a light guide plate which has marks with good visibility and in which generation of cracks is significantly suppressed. Further, the present invention can provide a method of manufacturing such a light guide plate.

### BRIEF DESCRIPTION OF THE DRAWINGS

Other objects and further features of the present disclosure will be apparent from the following detailed description when read in conjunction with the accompanying drawings, in which:

FIG. 1 is a diagram schematically illustrating an example of a dot formed by a plurality of laser irradiation marks that can be included in a light guide plate according to an embodiment of the present disclosure;

FIG. 2 is a perspective view schematically showing the light guide plate according to the embodiment of the present disclosure;

FIG. 3 is a diagram schematically showing an example of a mark formed on the light guide plate according to the embodiment of the present disclosure;

FIG. 4 is a diagram schematically showing an example of a mark element formed on the light guide plate according to the embodiment of the present disclosure;

FIG. 5 is an enlarged view schematically illustrating one dot constituting the mark element;

FIG. 6 is a cross-sectional view schematically showing the dot 140 cut along the line I-I in FIG. 5;

FIG. 7A is a diagram schematically illustrating the dot according to another aspect of the present application;

FIG. 7B is a diagram schematically illustrating an example of a dot formed by a plurality of laser irradiation marks that may be included in the light guide plate according to the other embodiment of the present disclosure;

FIG. 7C is a diagram schematically showing a form obtained when the centers of laser irradiation marks are connected in the dot shown in FIG. 7B;

FIG. 8 is a diagram schematically showing an example of a flow of a method of manufacturing a light guide plate according to the embodiment of the present disclosure;

FIG. 9 is a perspective view schematically showing a glass substrate used in the method of manufacturing the light guide plate according to the embodiment of the present disclosure;

FIG. 10 is a perspective view schematically showing a glass substrate on which a mark is formed in the method of manufacturing the light guide plate according to the embodiment of the present disclosure;

FIG. 11 is a diagram showing transmission characteristics of the glass substrate used in the example of the present disclosure;

FIG. 12 is a photograph of the surface of one dot formed in the example of the present disclosure;

FIG. 13 is a photograph of the surface of one dot formed in another example of the present disclosure;

FIG. 14 is a photograph of a surface of one dot formed in a comparative example; and

FIG. 15 is a photograph of the surface of one dot formed in the other example.

### DESCRIPTION OF THE EMBODIMENT

Hereinafter, an embodiment of the present disclosure will be described with reference to the drawings.

One embodiment of the present disclosure provides a light guide plate including a glass substrate having a mark on a surface thereof, a refractive index of the glass substrate being greater than or equal to 1.7, the mark being an identifier, an alignment mark, or a combination thereof, the mark including a plurality of dots, each of the dots being contained in a minimum circle having a diameter within a range of 30 μm to 250 μm, each of the dots having a raised portion higher than the surface of the glass substrate, the raised portion being at an outermost peripheral edge portion and at an innermost peripheral edge portion, in a cross section orthogonal to the surface, a height from a deepest portion of each of the dots to a highest position of the raised portion being from 0.11 μm to 4 μm, each of the dots being composed of an aggregate of laser irradiation marks, each having a diameter of 10 μm to 40 μm, the laser irradiation marks being in contact with or overlapping with adjacent laser irradiation marks, the laser irradiation marks forming at least one loop shape, a specific loop shape, which is a loop shape of the at least one loop shape having a diameter of a minimum circle containing the loop shape of less than or equal to 100 μm, being configured as an open loop including an open portion, a length of the open portion being greater than or equal to one tenth of a maximum diameter of the laser irradiation mark and less than or equal to twice the maximum diameter.

A light guide plate according to the embodiment of the present disclosure includes a glass substrate having a mark on a surface thereof. The mark includes a plurality of dots, and each of the dots is composed of an aggregate of laser irradiation marks, each having a diameter in a range of 10 μm to 40 μm. Further, the laser irradiation marks are arranged so as to be in contact with or overlap with adjacent laser irradiation marks.

In the present application, the “laser irradiation mark” means a concave portion formed on the surface of the glass substrate when the glass substrate is irradiated with a laser beam. Hereinafter, a laser irradiation mark having a maximum diameter in one dot will be referred to as a “maximum irradiation mark”, and the diameter of the “maximum irradiation mark” will be indicated by ϕₘₐₓ.

In one embodiment of the present disclosure, each dot has a size such that a diameter of a minimum circle containing the dot is in a range of 30 μm to 250 μm.

Further, each dot has a raised portion higher than other portions of the surface of the glass substrate at the outermost peripheral portion and the innermost peripheral portion. For example, the height of the raised portion may be greater than 0 μm and less than or equal to 2.0 μm from the surface. Furthermore, in one embodiment of the present disclosure, the height from the deepest portion of each dot to the maximum position of the raised portion is 0.1 μm to 4 μm.

In one embodiment of the present disclosure, the visibility of the mark can be enhanced by configuring each of the dots included in the mark to have the above-described dimensions.

Furthermore, the light guide plate according to the embodiment of the present disclosure has a feature that cracks are not likely to occur in the mark.

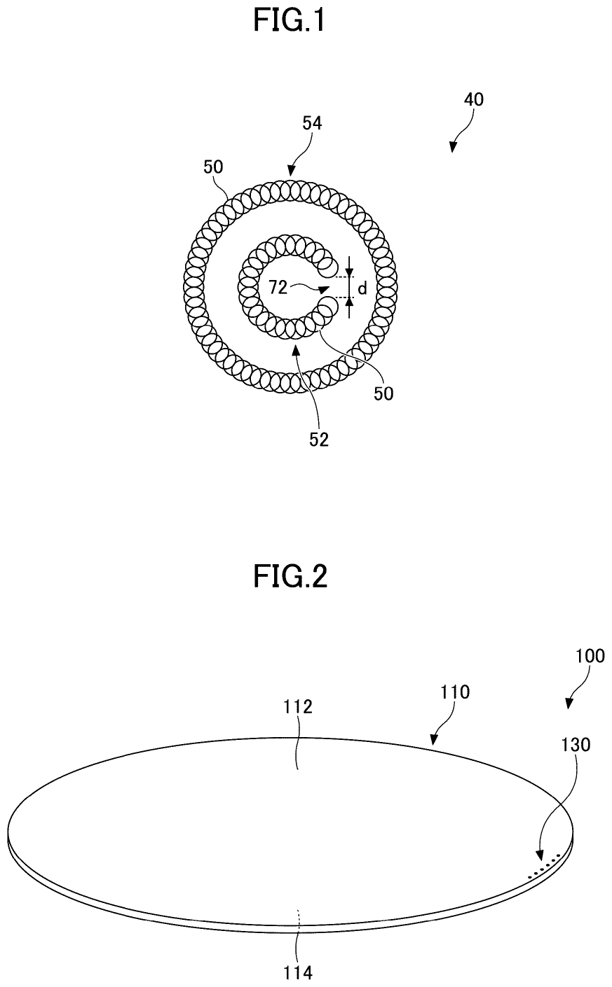

In the following, this feature will be described with reference to FIG. 1.

FIG. 1 schematically shows an example of a dot formed by a plurality of laser irradiation marks that can be included in the light guide plate according to the embodiment of the present disclosure.

As shown in FIG. 1, the dot 40 is configured as a substantially double ring having an inner ring 52 and an outer ring 54. Each of the inner ring 52 and the outer ring 54 is formed by arranging a plurality of laser irradiation marks 50 in an arc shape.

In the illustrated example, each of the inner ring 52 and the outer ring 54 is formed by arranging adjacent laser irradiation marks 50 so as to overlap each other. However, the arrangement mode of the laser irradiation marks 50 constituting the dots 40 is not limited thereto. For example, in the dot 40, the inner ring 52 and/or the outer ring 54 may be configured by arranging adjacent laser irradiation marks 50 so as to be in contact with each other. Alternatively, the inner ring 52 and/or the outer ring 54 may have a mixed configuration having both overlapping and contacting portions of adjacent irradiation marks 50.

Here, in the present application, an arrangement shape in which a closed region is formed when the center points of the closest laser irradiation marks 50 are sequentially connected is referred to as a “loop shape”.

For example, in each of the inner ring 52 and the outer ring 54 shown in FIG. 1, when the center points of the closest laser irradiation marks 50 are sequentially connected, a closed region surrounded by a substantially circular section is formed. Thus, the inner ring 52 and the outer ring 54 are “loop-shaped”.

In addition, in the present application, among the loop shapes determined as described above, a loop shape in which the diameter of the minimum circle containing the loop shape is less than or equal to 100 μm is particularly referred to as a “specific loop shape”.

Further, in the present application, among the “loop shapes”, a shape in which the laser irradiation mark 50 is necessarily present on the line defining the closed region drawn as described above is particularly referred to as a “closed loop”. On the other hand, in the “loop shape”, a shape in which the laser irradiation mark 50 is not present in a part of the line that defines the closed region is particularly referred to as an “open loop”.

According to this definition, in FIG. 1, the outer ring 54 is a “closed loop” because the laser irradiation marks 50 are always present on a closed figure (substantially a circle) formed by sequentially connecting the center points of the closest laser irradiation marks 50. On the other hand, in the inner ring 52, there is a place where the laser irradiation mark 50 is not on a part of a closed figure (substantially a circle) formed by sequentially connecting the center points of the closest laser irradiation marks 50. Thus, the inner ring 52 is an “open loop”.

Hereinafter, in the “open loop”, a portion where the laser irradiation mark 50 does not exist is referred to as an “open portion”.

In one embodiment of the present disclosure, at least one of the loop shapes formed by the laser irradiation mark 50 is formed as an “open loop”. In addition, in this “open loop”, the length of the “open portion” is selected to be greater than or equal to one tenth and less than or equal to twice the diameter ϕₘₐₓ of the laser irradiation mark having the maximum diameter among the laser irradiation marks included in the target dot, that is, the “maximum irradiation mark”.

For example, in the example of FIG. 1, the length d of the open portion 72 in the inner ring 52 is comparable to the diameter ϕₘₐₓ of the “maximum irradiation mark” by a factor of about 1. In FIG. 1, the laser irradiation marks 50 included in the dot 40 have substantially the same diameter, and thus each laser irradiation mark 50 corresponds to the “maximum irradiation mark”.

In one embodiment of the present disclosure, at least one “specific loop shape” is formed by the laser irradiation mark 50, and the specific loop shape is formed as an “open loop”.

Here, in a case where the specific loop shape of the dot 40 is a closed loop, there is a higher possibility that a crack occurs in the dot 40 during laser processing. This is because a large amount of heat is accumulated inside the specific loop shape having a small size.

On the other hand, when the specific loop shape of the dot 40 is configured as an open loop, heat can be dissipated from the open portion 72 at the time of laser irradiation, and a local increase in temperature in the loop is not likely to occur.

Therefore, in the light guide plate according to the embodiment of the present disclosure, unlike the case where the specific loop shape is formed of a closed loop, it is possible to significantly suppress the occurrence of cracks due to laser irradiation at the time of forming the mark.

Due to such effects, in one embodiment of the present disclosure, it is possible to provide a light guide plate which has a mark with good visibility and in which cracks are significantly suppressed.

### (Light Guide Plate According to One Embodiment of the Invention)

Hereinafter, the embodiment of the present disclosure will be described in more detail with reference to FIG. 2.

FIG. 2 is a schematic perspective view of a light guide plate according to the embodiment of the present disclosure.

As shown in FIG. 2, a light guide plate (hereinafter referred to as a “first light guide plate”) 100 according to the embodiment of the present disclosure includes a glass substrate 110 having a first surface 112 and a second surface 114 opposite to each other.

In the example shown in FIG. 1, the first surface 112 and the second surface 114 of the glass substrate 110 have a generally circular shape.

However, this is merely an example, and the shape of the glass substrate 110 is not particularly limited. For example, the first surface 112 and the second surface 114 of the glass substrate 110 may have a substantially elliptical shape, a substantially rectangular shape (including a substantially square shape), or the like.

A mark 130 is formed on the first surface 112 of the glass substrate 110.

The mark 130 may be, for example, an identifier including at least one of a number, a character, and a figure. Each of the number, the character, and the figure may be one or more. Such identifiers may be utilized, for example, to identify and/or manage the glass substrate 110.

Alternatively, the mark 130 may be, for example, an alignment mark. Such an alignment mark can be used for aligning the position and direction of the glass substrate 110 during processing such as handling, cutting, chamfering, and bonding.

In yet another embodiment, the mark 130 may be a combination of an identifier and an alignment mark.

Hereinafter, one number, character, and figure constituting the mark 130 is particularly referred to as a “mark element”.

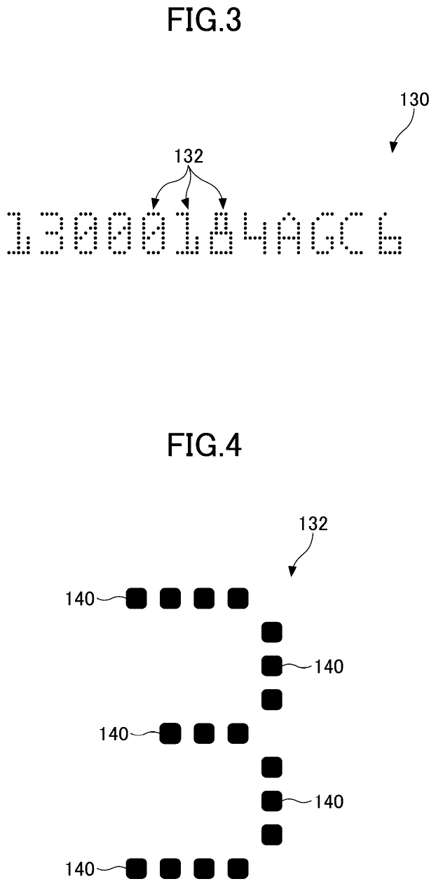

FIG. 3 schematically shows an example of the mark 130.

As shown in FIG. 3, in this example, the mark 130 is shown as an identifier composed of twelve mark elements 132 arranged in a line.

However, the mark 130 is not limited to such an aspect. For example, the mark 130 may be configured by arranging the respective mark elements 132 in a non-linear manner. The mark 130 may be configured such that the mark elements 132 are linearly or non-linearly arranged in two or more rows.

The mark element 132 will be described below with reference to FIG. 4.

FIG. 4 is an enlarged schematic view showing one of the mark elements 132 constituting the mark 130. In this example, the mark element 132 is viewed as the number “3”.

Each mark element 132 constituting the mark 130 is composed of a plurality of dots 140. In other words, one mark element 132 is formed by a plurality of dots 140.

For example, in the example shown in FIG. 4, the mark element 132 is formed by a combination of a total of 17 dots 140. The mark elements 132 other than the number “3” can also be formed by arranging the plurality of dots 140 vertically and horizontally.

Such dots 140 can be formed by irradiating the first surface 112 of the glass substrate 110 with a laser.

FIG. 5 shows a schematic enlarged view of one dot 140 constituting the mark element 132.

As shown in FIG. 5, the dot 140 is formed by combining a plurality of laser irradiation marks 150.

The diameter of each laser irradiation mark 150 is in a range of 10 μm to 40 μm. The diameter of each laser irradiation mark 150 is preferably in a range of 15 μm to 25 μm.

In the example shown in FIG. 5, the laser irradiation marks 150 have the same diameter, and thus each laser irradiation mark 150 corresponds to the maximum irradiation mark. However, the dot 140 may include a plurality of laser irradiation marks 150 having different diameters.

As shown in FIG. 5, adjacent laser irradiation marks 150 may be arranged so as to overlap each other. In this case, the overlapping ratio is preferably less than or equal to 80% and more preferably in the range of 30% to 80% in order to suppress cracks. Alternatively, adjacent laser irradiation marks 150 may be arranged so as to be in contact with each other. Alternatively, some adjacent laser irradiation marks 150 may be arranged to overlap each other, and other adjacent laser irradiation marks 150 may be arranged to be in contact with each other.

The dot 140 is composed of an inner first loop shape 152 and an outer second loop shape 154. Each of the first loop shape 152 and the second loop shape 154 is formed by arranging the laser irradiation marks 150 in a substantially square shape. The second loop shape 154 is disposed so as to surround the first loop shape 152.

In FIG. 5, for the following description, a minimum circle containing the first loop shape 152, that is, a circumscribed circle P₁ of the first loop shape 152, and a minimum circle containing the second loop shape 154, that is, a circumscribed circle P₂ of the second loop shape 154 are drawn.

Here, a diameter of the circumscribed circle P₁ of the first loop shape 152 is less than or equal to 100 μm. Therefore, the first loop shape 152 is a specific loop shape. Also, the first loop shape 152 is configured as an open loop including an open portion 172.

On the other hand, the diameters of the circumscribed circle P₂ of the second loop shapes 154 may be less than or equal to 100 μm, or greater than 100 μm. That is, the second loop shape 154 may or may not be a specific loop shape.

In the example of FIG. 5, the second loop shape 154 is a non-specific loop shape and is configured as a closed loop having no open portion. Alternatively, however, if the second loop shape 154 is a specific loop shape, then the second loop shape 154 is also configured as an open loop.

In the first loop shape 152, the length d of the open portion 172 is in a range of one tenth to twice the diameter ϕₘₐₓ of the maximum irradiation mark. The length d of the open portion 172 is preferably in a range of one fifth to 1 times the diameter ϕₘₐₓ of the maximum irradiation mark.

The diameter ϕ₁ of the circumscribed circle P₁ of the first loop shape 152 is in a range of 15 μm to 100 μm. The diameter ϕ₁ is preferably in a range of 25 μm to 90 μm, and more preferably in a range of 65 μm to 75 μm.

On the other hand, when the second loop shape 154 is a non-specific loop shape, the diameter ϕ₂ of the circumscribed circle P2 of the second loop shape 154 is preferably in a range of greater than 100 μm and less than or equal to 250 μm. The diameter ϕ₂ is preferably in a range of 110 μm to 210 μm, and more preferably in a range of 120 μm to 150 μm.

The form of the dot 140 is not limited to the “double” loop shape shown in FIG. 5. For example, the dot 140 may be configured in a “triple” or more loop shape. In addition, the form of the loop shape constituting the dot 140 is not particularly limited. The dots 140 may be formed in a plurality of ring-like loop shapes as shown in FIG. 1, for example.

However, in the embodiment of the present disclosure, at least one dot 140 constituting the mark 130 has one or more “specific loop shapes”. In addition, such a specific loop shape is configured as an “open loop”.

Each dot 140 has a raised portion at each of the innermost peripheral portion and the outermost peripheral portion.

Here, the “innermost peripheral portion” of the dot 140 corresponds to the outer periphery of the innermost region where the laser irradiation mark 150 does not exist in the dot 140. The “outermost peripheral portion” of the dot 140 corresponds to the outer periphery of the outermost region where the laser irradiation mark 150 is present in the dot 140.

For example, in the example shown in FIG. 5, the “innermost peripheral portion” of the dot 140 corresponds to the broken line portion Q₁ shown inside the first loop shape 152. The “outermost peripheral portion” of the dot 140 corresponds to the broken-line portion Q₂ shown outside the second loop shape 154.

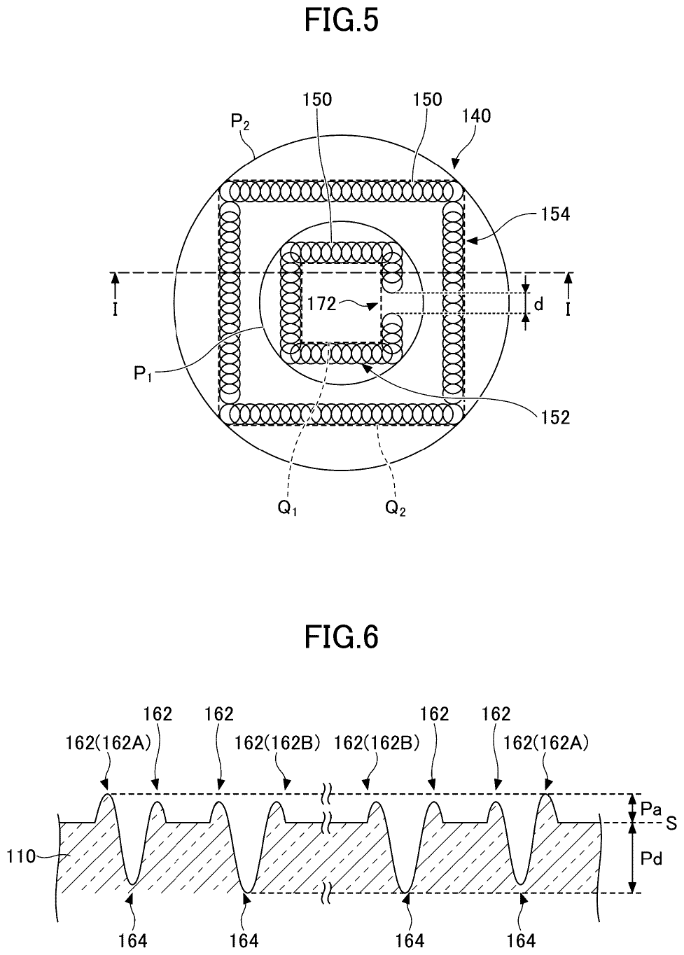

Hereinafter, the cross-sectional profile of the dot 140 will be described with reference to FIG. 6.

FIG. 6 schematically shows a cross section taken along the line I-I of the dot 140 shown in FIG. 5. In FIG. 6, a portion of the first surface 112 of the glass substrate 110 where the mark 130 is not formed is depicted as a reference surface S.

As shown in FIG. 6, the dot 140 has a plurality of raised portions 162 and valley portions 164 corresponding to the first loop shape 152 and the second loop shape 154.

In FIG. 6, the raised portion 162A corresponds to the outermost peripheral portion of the dot 140, and the raised portion 162B corresponds to the innermost peripheral portion of the dot 140.

In the dot 140, the distance from the reference surface S to the tip of one of the raised portion 162A and the raised portion 162B having the maximum height from the reference surface S is referred to as a “maximum height” and represented by a symbol Pa.

In addition, a distance from the reference surface S to the tip of the valley portion 164 having the maximum depth is referred to as a “maximum depth” and represented by a symbol Pd.

In this case, the maximum height Pa may be greater than 0 μm and less than or equal to 2 μm. The height (Pa+Pd) from the deepest portion of the valley portion 164 to the maximum position of the raised portion 162A is in the range of 0.1 μm to 4 μm.

By making the cross-section of the dot 140 have such a shape and dimension, the visibility of each mark element 132 and further the mark 130 can be significantly enhanced.

The maximum height Pa is preferably in a range of 1 μm to 1.5 μm. The height (Pa+Pd) is preferably in a range of 2 μm to 3 μm.

In the first light guide plate 100, cracks in each dot 140 are significantly suppressed, and the mark 130 with high visibility can be obtained.

### (Each Component of Light Guide Plate)

Next, each component of the light guide plate according to the embodiment of the present disclosure will be described.

Here, the first light guide plate 100 described above is taken as an example and its elements will be described. Therefore, the reference numerals used in FIGS. 1 to 6 are used to represent the respective portions.

### (Glass Substrate 110)

### (Composition)

The glass substrate 110 used in the first light guide plate 100 has a refractive index of greater than or equal to 1.7.

The glass substrate 110 may contain at least one element selected from the group of lanthanum (La), titanium (Ti), niobium (Nb), tantalum (Ta), tungsten (W), bismuth (Bi), and tellurium (Te).

By containing these elements (hereinafter referred to as “specific elements”), the refractive index of the glass substrate 110 can be increased. Each of the specific elements has absorption in the ultraviolet region. Therefore, in the case where the glass substrate 110 contains the specific element, when the glass substrate 110 is irradiated with the UV laser to form the mark 130, absorption efficiency can be increased.

The specific element may be contained in a total amount of 1% by mass or more in terms of oxide. Hereinafter, unless otherwise specified, all concentrations of glass components are expressed in units of mass %.

When the glass substrate 110 contains Ti, the content of Ti in terms of TiO₂ is, for example, greater than 0% and less than or equal to 35% when the total of the base composition is 100%. When TiO₂ is contained, the glass can also be stabilized.

The content of TiO₂ is preferably greater than or equal to 1%, more preferably greater than or equal to 5%, still more preferably greater than or equal to 7%, particularly preferably greater than or equal to 10%. In addition, when the content of TiO₂ is less than or equal to 35%, the devitrifying temperature is lowered and the coloration of the glass can be suppressed. The content of TiO₂ is preferably less than or equal to 25%, more preferably less than or equal to 20%, and still more preferably less than or equal to 15%.

When the glass substrates 110 contain W, the content of W in terms of WO 3 is, for example, greater than 0 and less than or equal to 30% when the total of the base composition is 100%.

The content of WO₃ is preferably greater than or equal to 1%, more preferably greater than or equal to 3%, still more preferably greater than or equal to 5%, particularly preferably greater than or equal to 10%.

When the content of WO₃ is less than or equal to 30%, the devitrifying temperature is lowered and the coloration of the glass can be suppressed. The content of WO₃ is preferably less than or equal to 20%, more preferably less than or equal to 15%.

When the glass substrates 110 contain Bi, the content of Bi in terms of Bi₂O₃ is, for example, greater than 0% and less than or equal to 55% when the total of the base composition is 100%.

The content of Bi₂O₃ is preferably greater than or equal to 1%, more preferably greater than or equal to 5%, still more preferably greater than or equal to 5%, particularly preferably greater than or equal to 10%.

When the content of Bi₂O₃ is less than or equal to 55%, the devitrifying temperature is lowered and the coloration of the glass can be suppressed. The content of Bi₂O₃ is preferably less than or equal to 35%, more preferably less than or equal to 25%, and still more preferably less than or equal to 15%.

When the glass substrate 110 contains Ta, the content of Ta in terms of Ta₂O₅ is, for example, greater than 0% and less than or equal to 30% when the total of the base composition is 100%.

The content of Ta₂O₅ is preferably greater than or equal to 1%, more preferably greater than or equal to 5%.

When the content of Ta₂O₅ is less than or equal to 30%, the devitrifying temperature can be lowered and the material cost can be reduced. The content of Ta₂O₅ is preferably less than or equal to 25%, more preferably less than or equal to 10%.

When the glass substrate 110 contains Nb, the content of Nb in terms of Nb₂O₅ is, for example, greater than 0% and less than or equal to 35% when the total of the base composition is 100%.

The content of Nb₂O₅ is preferably greater than or equal to 5%, more preferably greater than or equal to 10%, and still more preferably greater than or equal to 15%.

When the content of Nb₂O₅ is less than or equal to 35%, the devitrifying temperature can be lowered and the material cost can be reduced. The content of Nb₂O₅ is preferably less than or equal to 30%, more preferably less than or equal to 25%.

The glass substrate 110 may contain, for example, 5 to 80% of at least one selected from the group consisting of SiO₂, B₂O₃, and P₂O₅, as the base composition, represented by mass % based on oxides; 5 to 70% in total of at least one oxide selected from the group consisting of MgO, CaO, SrO, BaO, ZnO, Li₂O, Na₂O, K₂O, Cs₂O, Ln₂O₃ (Ln is at least one selected from the group consisting of Y, La, Gd, Yb, and Lu), as a modifier oxide; and 0 to 50% in total of at least one oxide selected from the group consisting of Al₂O₃, TiO₂, ZrO₂, WO₃, Bi₂O₃, TeO₂, Ta₂O₅, and Nb₂O₅, as an intermediate oxide.

The glass having such a composition has a high refractive index, good light transmittance, and high solubility.

Specific examples the glass include, according to the base composition, (1) La—B based glass, (2) SiO₂ based glass, and (3) P₂O₅ based glass.

### (Refractive Index)

The glass according to the embodiment of the present disclosure has a refractive index of greater than or equal to 1.7. The refractive index is preferably greater than or equal to 1.73, more preferably greater than or equal to 1.75, more preferably greater than or equal to 1.77, more preferably greater than or equal to 1.79, more preferably greater than or equal to 1.81, more preferably greater than or equal to 1.83, more preferably greater than or equal to 1.85, more preferably greater than or equal to 1.87, more preferably greater than or equal to 1.89, more preferably greater than or equal to 1.91, more preferably greater than or equal to 1.93, more preferably greater than or equal to 1.95, more preferably greater than or equal to 1.955, more preferably greater than or equal to 1.959, more preferably greater than or equal to 2.05, more preferably greater than or equal to 2.10. As the refractive index of a light guide plate used in a wearable device that enables virtual reality (VR), augmented reality (AR), and mixed reality (MR) is higher, there is an advantage in that a field of view (FOV) can be increased.

### (Processes)

The method of manufacturing the glass substrate 110 is not particularly limited. For example, glass composition components are mixed and heated and melted in a glass melting furnace. The glass is homogenized by bubble stirring, addition of a fining agent, or the like, and formed into a plate shape having a predetermined thickness by a known method such as a slip casting method, a float method, a press method, a fusion method, or a downdraw method.

Then, after the slow cooling, processing such as outer shape processing, grinding, and polishing is performed as necessary to obtain a glass raw material plate having a predetermined size and shape. As the forming method, a float method or a continuous forming method other than the float method, that is, a fusion method or a down-draw method can also be performed. Alternatively, a molten glass may be cast in a mold and the obtained ingot may be sliced into a plate shape, or a so-called E-Bar glass may be formed by slip casting suitable for a continuous forming method and cut into an appropriate size to form a glass plate.

The method of manufacturing the glass substrate 110 from the raw material glass plate thus obtained may include the following steps.

### (1) Shape Imparting Step

The raw glass plate obtained by the above-described manufacturing method is processed into a predetermined shape, for example, a disk shape, and then the outer peripheral side surface is chamfered.

### (2) Main Surface Grinding Step

Both upper and lower main surfaces of the glass substrate 110 are subjected to grinding (lapping) processing using a free abrasive grain or a fixed abrasive grain tool. This step may be carried out before the shape imparting step.

### (3) End Surface Polishing Step

Further, in order to prevent chipping or the like of the end surface, the outer peripheral end surface in which the outer peripheral side surface of the glass substrate and the outer peripheral chamfered portion are combined may be polished.

### (4) Main Surface Polishing Step

Both upper and lower main surfaces of the glass substrate 110 are polished. In the step of polishing the main surface, only primary polishing may be performed, or primary polishing and secondary polishing may be performed. After the secondary polishing, tertiary polishing may be further performed. In the main surface polishing step, the final polishing step is referred to as a finishing polishing step.

### (5) Washing Step

The glass substrate is subjected to precision cleaning to produce a glass substrate 110. Scrub cleaning (rubbing) with a detergent, ultrasonic cleaning in a state of being immersed in a detergent solution, and ultrasonic cleaning in a state of being immersed in pure water are sequentially performed, and drying is performed with isopropyl alcohol.

In the case of scrub washing, a PVA sponge sufficiently soaked with water or a diluted detergent is prepared and washed while being sprinkled with water or a diluted detergent or in a submersion tank or a detergent tank, and examples of the detergent include a neutral detergent, an alkaline detergent, and an acidic detergent. Examples of the cleaning method include a method of holding the surface of the glass substrate 110 or the outer periphery of the glass substrate 110 by hand, placing the glass substrate on a PVA sponge, and rubbing the glass substrate surface or the outer periphery of the glass substrate while pressing the glass substrate against the PVA sponge, a method of gripping the surface of the glass substrate 110 with a PVA sponge and rubbing the glass substrate surface through the PVA sponge in a gripped state, and a method of holding the outer periphery of the glass substrate 110 by hand, sandwiching the glass substrate 110 between two or more PVA sponges fixed to a workbench, and rubbing the glass substrate surface. These methods may be combined with a method of moving one or both of the glass substrate 110 and the PVA sponge a plurality of times and feeding them in a specific direction while rubbing them, a method of feeding them in an unspecified direction, a method of feeding them while rotating them, or the like. The pressure at the time of cleaning can be appropriately adjusted by a method in which the pressing pressure is adjusted by hand so that the glass substrate 110 is not broken, a method in which the clearance between the PVA sponges is adjusted according to the thickness of the glass substrate 110, or the like.

### (Other Characteristics)

The glass substrate 110 preferably has a composition in which the average internal transmittance at a wavelength of 300 nm to 400 nm is less than or equal to 30%.

Since such glass substrates 110 have absorption in the ultraviolet region, when forming the marks 130, for example, a UV laser having a 355 nm wavelength can be used to perform good marking with a short tact time or low power. The average internal transmittance in the wavelength of 300 nm to 400 nm is more preferably less than or equal to 20%.

The glass substrate 110 preferably has a thermal expansion coefficient in a range of 40×10⁻⁷/K to 100×10⁻⁷/K.

When the thermal expansion coefficient of the glass substrate 110 is in the above range, local thermal expansion of the glass substrate 110 is suppressed at the time of irradiation with laser light. Therefore, it is possible to obtain the dot 140 with less cracks.

The roughness (root mean square height) Rq of the first surface 112 of the glass substrate 110 may be less than or equal to 1 nm. By setting the roughness Rq of the first surfaces 112 of the glass substrates 110 to be less than or equal to 1 nm, when the first light guide plate 100 is applied to a wearable device, scattering factors of light can be significantly suppressed. This Rq is more preferably less than or equal to 0.5 nm, still more preferably less than or equal to 0.3 nm.

The glass substrate 110 may have a degree of parallelism of less than or equal to 10 μm. By setting the degree of parallelism of the glass substrate 110 to less than or equal to 10 μm, it is possible to significantly suppress variations in the optical path when the first light guide plate 100 is applied to a wearable device. The degree of parallelism is more preferably less than or equal to 5 μm, still more preferably less than or equal to 2 μm.

The thickness of the glass substrate 110 is not particularly limited. The glass substrate 110 may have a thickness of, for example, less than or equal to 1 mm. The light guide plate used in the wearable device is preferably thin for weight reduction, and may have a thickness of, for example, less than or equal to 0.5 mm, more preferably less than or equal to 0.3 mm. On the other hand, in order to maintain good light guiding characteristics, the thickness is preferably greater than or equal to 0.1 mm. When the thickness is in this range, laser marking without cracks is possible.

### (Dot 140)

As described above, the dot 140 has the raised portion 162 at the outermost peripheral portion and the innermost peripheral portion. Further, the dot 140 has a valley portion 164 at a position corresponding to the center of the laser irradiation mark 150 in a cross-sectional view.

As described above, the maximum height Pa of the raised portion 162 is greater than 0 and less than or equal to 2 μm. The maximum height Pa of the raised portion 162 is preferably greater than or equal to 1 μm. The height (Pa+Pd) from the deepest portion of the valley portion 164 to the maximum position of the raised portion 162 is in the range of 0.1 μm to 4 μm. The height (Pa+Pd) is preferably in the range of 2 μm to 3 μm.

In the above-described examples shown in FIGS. 1 and 5, the inner ring 52 and the first loop shape 152 have one open portion 72 and one open portion 172, respectively.

However, this is merely an example, and in an exemplary embodiment, the dot 140 may have a plurality of openings.

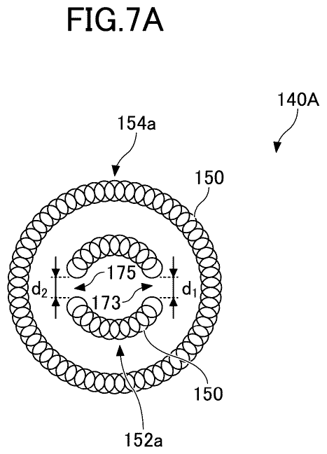

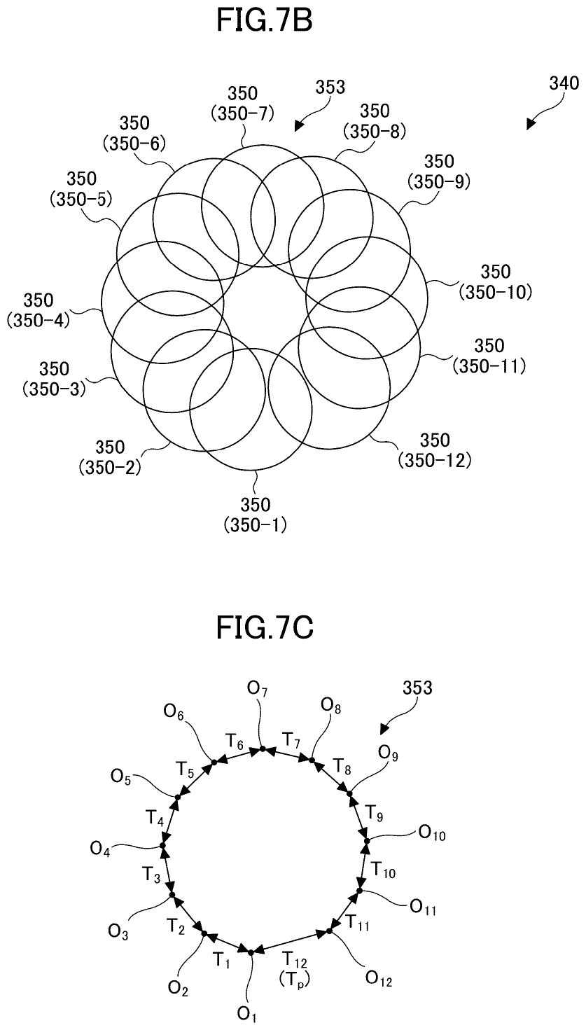

FIG. 7A shows another configuration example of the dot.

In the example shown in FIG. 7A, the dot 140A has a substantially double ring structure of an inner ring 152a and an outer ring 154a. Further, the inner ring 152a has a specific loop shape and is configured to have an open loop shape.

However, in FIG. 7A, unlike the case of FIG. 1, the inner ring 152a has two open portions. That is, in this example, the first open portion 173 and the second open portion 175 are provided at positions facing each other in the inner ring 152a.

Each of the length d₁ of the first open portion 173 and the length d₂ of the second open portion 175 is in a range of one tenth to twice the diameter ϕₘₐₓ of the maximum irradiation mark 150.

Thus, the open loop of the particular loop shape may have a plurality of open portions.

It will be apparent to those skilled in the art that various other configurations can be assumed as the configuration of the dot.

As a result of subsequent studies, the inventors of the present invention have found that the specific loop shape is not necessarily an “open loop” in order to achieve the object of the present invention. That is, even if the specific loop shape is a “closed loop”, when such a “closed loop” satisfies a specific condition, it is possible to provide a light guide plate which has a mark with good visibility and in which cracks are significantly suppressed.

Accordingly, another embodiment of the present disclosure provides a light guide plate including a glass substrate having a mark on a surface thereof, a refractive index of the glass substrate being greater than or equal to 1.7, the mark being an identifier, an alignment mark, or a combination thereof, the mark including a plurality of dots, each of the dots is contained in a minimum circle having a diameter within a range of 30 μm to 250 μm, each of the dots having a raised portion higher than the surface of the glass substrate, the raised portion being at an outermost peripheral edge portion and at an innermost peripheral edge portion, in a cross section orthogonal to the surface, a height from a deepest portion of each of the dots to a highest position of the raised portion being from 0.11 μm to 4 μm, each of the dots being composed of an aggregate of laser irradiation marks, each having a diameter of 10 μm to 40 μm, the laser irradiation marks being in contact with or overlapping with adjacent laser irradiation marks, the laser irradiation marks forming at least one loop shape, a specific loop shape, which is a loop shape of the at least one loop shape having a diameter of a minimum circle containing the loop shape of less than or equal to 100 μm, being configured as a closed loop, sets of the laser irradiation marks adjacent to each other including first to n-th sets, an integer n being greater than or equal to 10, and T being a distance between centers of the adjacent laser irradiation marks in each set, the sets of the laser irradiation marks adjacent to each other including average sets and one or more specific sets, in each of the average sets, a difference between the distance T and a distance Tₐᵥₑ, which is an average of the distances T in the average sets, being within a range of ±1% of the distance Tₐᵥₑ, in each of the one or more specific sets, a difference between the distance T and the distance Tₐᵥₑ being outside the range of ±1% of the distance Tₐᵥₑ, the average sets being, in number, greater than or equal to 90% of all the sets, and a distance Tₚ between centers of the adjacent laser irradiation marks in each of the one or more specific sets being greater than the distance Tₐᵥₑ by one tenth of a maximum diameter of the laser irradiation mark.

Here, the center of each laser irradiation mark can be confirmed by observing the cross section of the dot. That is, in FIG. 6, the valley portion 164 corresponds to the irradiation center of the laser beam. Therefore, by measuring the center-to-center distance between two corresponding valley portions 164 in two adjacent laser irradiation marks, the center-to-center distance between the laser irradiation marks in each set can be obtained.

Hereinafter, the present embodiment will be specifically described with reference to FIGS. 7B and 7C.

FIG. 7B schematically illustrates an example of a dot including a plurality of laser irradiation marks that may be included in the light guide plate according to the other embodiment of the present disclosure. FIG. 7C schematically shows a form obtained when the centers of the laser irradiation marks are connected in the dot shown in FIG. 7B.

As shown in FIGS. 7B and 7C, this dot 340 is configured as a single ring 353. The ring 353 is configured by arranging a total of twelve laser irradiation marks 350 (referred to as “350-1” to “350-12”, respectively) in an arc shape.

As illustrated in FIG. 7C, the ring 353 has an arrangement in which a closed region is formed when the center points of the closest laser irradiation marks 350 (referred to as “O₁” to “O₁₂”, respectively) are sequentially connected. Thus, according to the above definition, the ring 353 is “loop-shaped”.

In addition, a diameter of a minimum circle containing the ring 353 is less than or equal to 100 μm, and thus the ring 353 has a “specific loop shape”.

Further, in the dot 340, because the laser irradiation mark 350 is present at any position on the line that defines the closed region of the “loop shape”, the ring 353 is a “closed loop”.

Here, even if the ring 353 is a “closed loop”, when the ring is provided with the following characteristics, it is possible to obtain the dot 340 in which cracks are not likely to occur.

(Configuration of Closed Loop for Obtaining Dot in which Crack is not Likely to Occur)

Sets of adjacent laser irradiation marks will be referred to as a first set, a second set, . . . , and an n-th set. Here, one laser irradiation mark included in the first set is also a laser irradiation mark included in the second set. The same applies to the second set, . . . , the n-th set. Further, an integer n is greater than or equal to 10.

In each set, when the center-to-center distance between laser irradiation marks is denoted by T, greater than or equal to 90% and less than 100% of all sets have the “equivalent” center-to-center distance T. Here, “equivalent” means that the difference in center-to-center distance is within ±2%. Such sets that are greater than or equal to 90% in number will be referred to as “average sets”, and an average of the center-to-center distances T of the “average sets” will be referred to as Tₐᵥₑ.

Note that some sets not included in the “average set” will be referred to as “specific sets”. The number of specific sets may be one or more, but is less than 10% of the total number of sets at the maximum.

In each of the specific sets, the center-to-center distance between the laser irradiation marks is larger than Tₐᵥₑ. More specifically, when the center-to-center distance between the laser irradiation marks in each specific set is denoted by Tₚ, Tₚ is larger than Tₐᵥₑ by one tenth or more of the maximum diameter ϕₘₐₓ of the laser irradiation mark included in the dot. That is, Tₚ≥Taᵥₑ+(ϕₘₐₓ/10).

In particular, Tₚ preferably satisfies Tₚ≥Tₐᵥₑ+(ϕₘₐₓ/3). For example, Tₚ≥Tₐᵥₑ+(ϕₘₐₓ/2) may be satisfied.

In the case of Tₚ>ϕₘₐₓ, the above-described open loop configuration is obtained.

In addition, from the viewpoint of visibility, Tₚ preferably satisfies Tₚ≤Tₐᵥₑ+2ϕₘₐₓ.

When the “closed loop” is formed in such a manner, it is possible to obtain a dot in which cracks are not likely to occur.

For example, in the example of FIGS. 7B and 7C described above, laser irradiation marks 350-1 and 350-2 constitute a first set, laser irradiation marks 350-2 and 350-3 constitute a second set, laser irradiation marks 350-3 and 350-4 constitute a third set, and so on.

In addition, the center-to-center distance T₁ between O₁ and O₂ of the first set, the center-to-center distance T₂ between O₂ and O₃ of the second set, . . . , and the center-to-center distance T₁₁ between O₁₁ and O₁₂ of the eleventh set are all equal to each other. Thus, each set is an average set and their center-to-center distance is Tₐᵥₑ.

On the other hand, the center-to-center distance T₁₂ between O₁₂ and O₁ in the twelfth set is larger than the center-to-center distance Tₐᵥₑ in the average set by one tenth or more of the maximum diameter ϕₘₐₓ of the laser irradiation mark 350. Therefore, the twelfth set is a “specific set”, and the center-to-center distance T₁₂ is equal to Tₚ.

Although the dot 340 having such a form has a “closed loop”, it is possible to significantly suppress an occurrence of a crack in the dot 340 at the time of laser processing.

### (First Light Guide Plate 100)

The first light guide plate 100 having the above-described characteristics includes a glass substrate 110 having a high refractive index. Therefore, the first light guide plate 100 can be applied to, for example, a wearable device that enables virtual reality (VR), augmented reality (AR), and mixed reality (MR).

### (Method of Manufacturing Light Guide Plate According to One Embodiment)

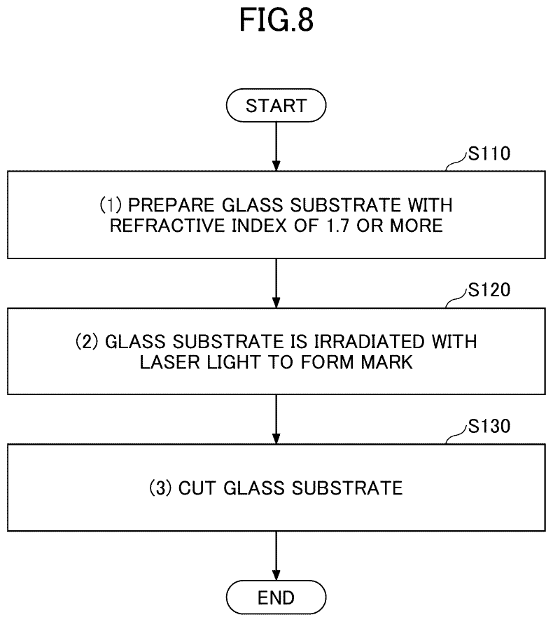

Next, an example of a method of manufacturing a light guide plate according to the embodiment of the present disclosure will be described with reference to FIGS. 8 to 10.

FIG. 8 schematically shows an example of a flow of the method of manufacturing a light guide plate according to the embodiment of the present disclosure (hereinafter referred to as a “first manufacturing method”).

As shown in FIG. 8, the first manufacturing method includes:
(1) preparing a glass substrate having a refraction index of greater than or equal to 1.7 (step S110);
(2) irradiating the glass substrate with laser light, to form a mark (step S120); and
(3) cutting the glass substrates (step S130).

It should be noted that the step S130 may be performed as necessary, and is not necessarily required.

Hereinafter, each step will be described in more detail.

### (Step S110)

First, a glass substrate having a refractive index of greater than or equal to 1.7 is prepared.

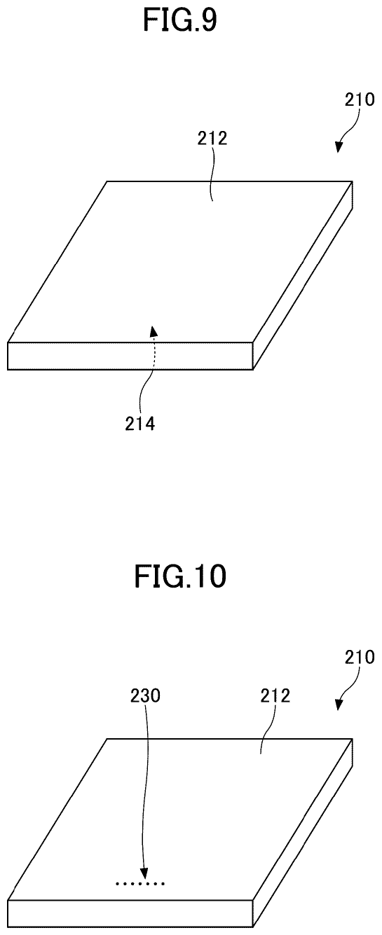

FIG. 9 is a schematic perspective view of the glass substrate.

As shown in FIG. 9, the glass substrate 210 has a first surface 212 and a second surface 214 opposite to each other.

In the example shown in FIG. 9, the first surface 212 and the second surface 214 of the glass substrate 210 have substantially rectangular shapes, but the shapes of the first surface 212 and the second surface 214 are not particularly limited. For example, the first surface 212 and the second surface 214 may be circular or elliptical. Further, the first surface 212 and/or the second surface 214 of the glass substrate 210 may have a curved surface.

The glass substrate 210 may include the above-described “specific element” and have the above-described composition.

In addition, glass substrate 210 may have an average internal transmittance of less than or equal to 30% at a wavelength of 300 nm to 400 nm. In such a glass substrate 210, a mark can be formed by irradiation with UV laser light.

The glass substrate 210 may have a roughness (root mean square height) Rq of less than or equal to 1 nm and a parallelism of less than or equal to 10 μm.

The thicknesses of the glass substrates 210 are not particularly limited, but may be less than or equal to the 1 mm, for example.

### (Step S120)

Next, the first surface 212 of the glass substrate 210 is irradiated with laser light. Thus, a mark can be formed on the first surface 212 of the glass substrate 210.

FIG. 10 schematically shows the glass substrate 210 in which the mark 230 is formed at the center of the first surface 212.

The arrangement position of the mark 230 is not particularly limited. The number of marks 230 is not particularly limited, and a plurality of marks may be formed on the first surface 212 of the glass substrate 210.

As described above, the mark 230 may be an identifier, an alignment mark, or a combination thereof.

Each mark element constituting the mark 230 is constituted by a plurality of dots including a laser irradiation mark. Each dot is constituted by an aggregate of laser irradiation marks having a diameter in a range of 10 μm to 40 μm. In each dot, the laser irradiation mark is arranged so as to be in contact with or overlap with an adjacent laser irradiation mark.

Also, each dot has the features described above.

That is, each dot has a size such that the diameter of the smallest circle containing the dot is in the range of 30 μm to 250 μm.

Further, each dot has a raised portion higher than the first surface 212 of the glass substrate 210 at the outermost peripheral portion and the innermost peripheral portion. The height of the raised portion may be, for example, greater than 0 μm and less than or equal to 2.0 μm from the first surface 212. The height from the deepest portion of each dot to the maximum position of the raised portion is 0.1 μm to 4 μm.

Further, in each dot, the laser irradiation mark constitutes at least one loop shape.

At least one of the loop shapes is a specific loop shape, and the specific loop shape is configured as an open loop including an opening. The length of the open portion is adjusted to be greater than or equal to one tenth and less than or equal to twice the diameter ϕₘₐₓ of the maximum irradiation mark.

The dots having such a form can be formed by irradiating the first surfaces 212 of the glass substrates 210 with UV laser light having a wavelength in the range of 150 nm to 370 nm. The wavelength of the laser light may be, for example, in the range of 260 nm to 360 nm.

The laser beam may be a pulse laser beam having a pulse width in the range of 40 kHz to 400 kHz. The power of the laser light is in the range of 0.5 W to 4.0 W.

When the dots included in the mark 230 are formed in the above-described manner, generation of cracks can be significantly suppressed when the dots are formed on the glass substrate 210 by irradiation with laser light. In addition, after the laser irradiation, the mark 230 having excellent visibility can be formed.

### (Step S130)

Through the steps described above, the glass substrate 210 on which the mark 230 is formed, that is, the light guide plate can be manufactured.

However, in the first manufacturing method, the obtained glass substrate 210 may be cut thereafter. A method of cutting the glass substrate 210 is not particularly limited. The glass substrate 210 may be cut using conventional cutting methods.

By cutting the glass substrate 210, it is possible to obtain a light guide plate having a predetermined size and shape on which the mark 230 is formed. In particular, when a plurality of marks 230 are formed on the first surfaces 212 of the glass substrates 210 in the above-described step S120, a plurality of light guide plates can be obtained from one glass substrate 210 by cutting the glass substrate 210 into a plurality of pieces each having the mark 230.

When the mark 230 is an alignment mark, the cutting position or shape can be accurately controlled based on the position of the mark 230.

The method of manufacturing a light guide plate according to the embodiment of the present disclosure has been described above using the first manufacturing method as an example. However, the above description is merely an example, and it will be apparent to those skilled in the art that the light guide plate according to the embodiment of the present disclosure may be manufactured by other methods.

### EXAMPLES

Next, examples of the present disclosure will be described. In the following description, Example 1 and Example 2 are practical examples, and Example 11 is a comparative example.

### Example 1

A plurality of dots were formed on one surface (first surface) of the glass substrate by laser light irradiation.

For the glass substrates, 0.3 mm thick high-refractive-index glass (M130; manufactured by AGC Inc.) was used. The refractive index of the glass substrate was 2.

The first surfaces of the glass substrates had a roughness (root mean square height) Rq of 0.5 nm and a parallelism of less than or equal to 1 μm.

As the laser beam, a UV laser having a wavelength of 355 nm was used. Ten dots were formed along one line.

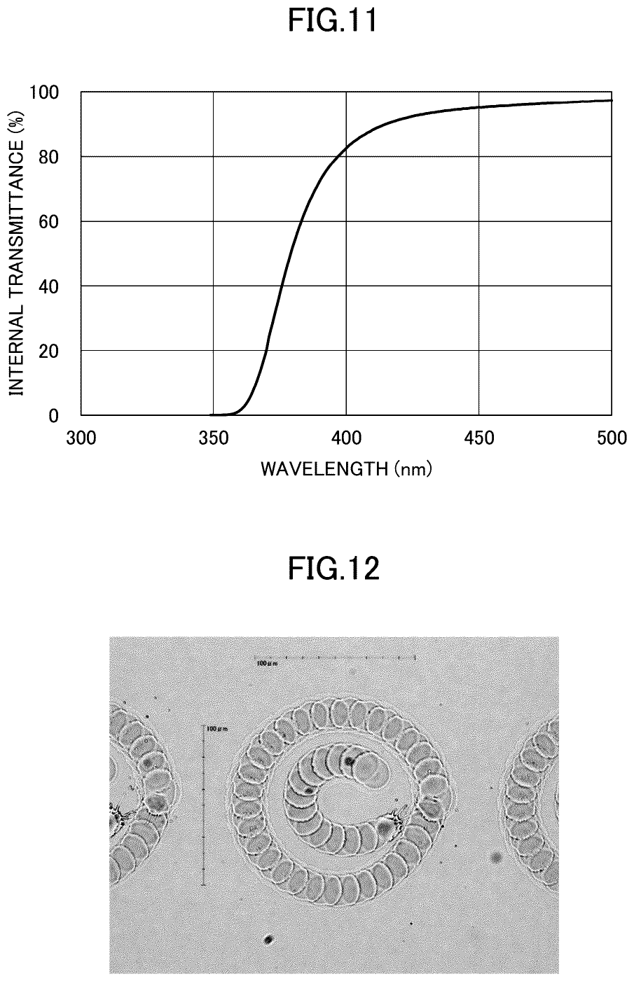

FIG. 11 shows the internal transmission characteristics of the glass substrate used. It can be seen from FIG. 11 that the glass substrates used have significantly suppressed internal transmittances at a wavelength of 300 nm to 400 nm.

The dots had a double ring structure as shown in FIG. 1 above. The inner ring had a specific loop shape and the outer ring had a non-specific loop shape. The inner ring was an open loop, and the outer ring was a closed loop. It is to be noted that the diameters of the laser irradiation marks were all set to the same diameter.

After the laser irradiation, the size and shape of the formed dots were measured.

FIG. 12 shows a photograph of the surface of one dot formed.

After the laser irradiation, the glass substrate, particularly the dots were observed, and no abnormalities such as cracks were observed.

In addition, the mark formed on the glass substrate was visually recognized clearly.

### Example 2

A plurality of dots were formed on one surface of the glass substrate in the same manner as in Example 1.

However, in Example 2, the inner ring of the double ring-shaped structure was formed in a shape having open portions at two opposing positions. The length d of the open portion was the same in all cases.

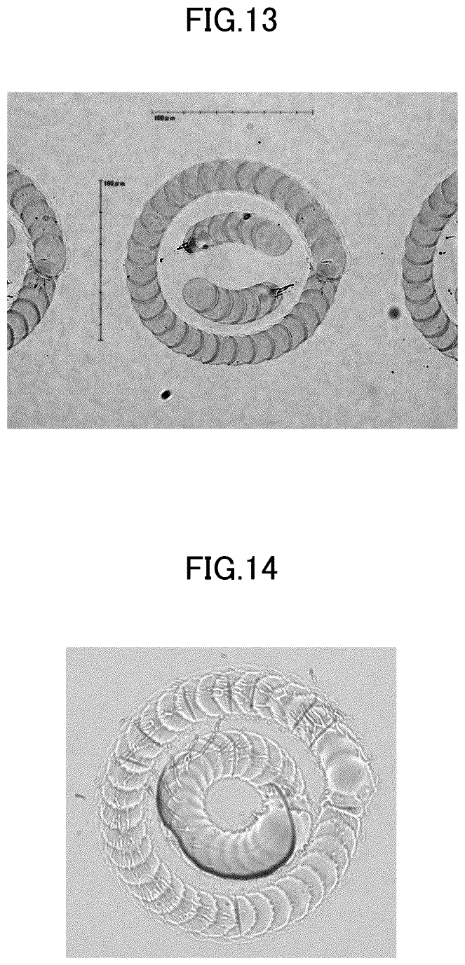

FIG. 13 shows a photograph of the surface of one dot formed.

After the laser irradiation, the glass substrate, particularly the dots were observed, and no abnormalities such as cracks were observed.

Further, the mark formed on the glass substrate was clearly visible.

### Example 11

A plurality of dots were formed on one surface of the glass substrate in the same manner as in Example 1.

However, in Example 11, the inner ring of the double ring structure was a closed loop.

In particular, the center-to-center distance between adjacent dots was substantially constant.

FIG. 14 shows a photograph of the surface of one dot formed.

When the dots were observed after the laser irradiation, it was recognized that many cracks were generated.

TABLE 1 below summarizes the measurement results of the dimensions of the dots formed in each example.

TABLE 1

| | | Maximum | Diameter of | Diameter of | | | | |
|---|---|---|---|---|---|---|---|---|
| | Average | diameter of | minimum | minimum | | | | |
| | diameter of | laser | circle | circle | Length of | | | |
| | laser | irradiation | including | including | open | | | |
| | irradiation | mark ϕₘₐₓ | outer ring | inner ring | portion d | d/ϕₘₐₓ | Occurrence | Visibility |
| Ex | mark (μm) | (μm) | (μm) | (μm) | (μm) | (μm) | of Crack | of dot |
| 1 | 19.6 | 21.9 | 126.3 | 68.3 | 21 | 0.96 | NO | Excellent |
| 2 | 19.6 | 21.6 | 130.2 | 69.8 | 20.6 | 0.95 | NO | Excellent |
| 11 | 21.1 | 21.7 | 120.8 | 66.6 | — | 0 | YES | Excellent |

TABLE 2 below shows the measurement results in the depth direction of the dots in Example 1.

TABLE 2

| | Distance from reference | Distance from reference | Distance from reference | |
|---|---|---|---|---|
| | surface to tip of raised | surface to tip of raised | surface to tip of valley | |
| | portion at outermost | portion at innermost | portion having maximum | Pa + Pd |
| Ex | peripheral portion (μm) | peripheral portion (μm) | depth Pd (μm) | (μm) |
| 1 | 0.10 | 0.10 | 0.35 | 0.45 |

A stylus type step profiler was used to measure the height (depth) of each portion shown in TABLE 2.

As described above, it was confirmed that the occurrence of cracks was significantly suppressed by setting the specific loop shape to an open loop in the dot. In addition, it was confirmed that good visibility can be obtained in the dots by providing raised portions at the outermost peripheral edge portion and the innermost peripheral edge portion of the dots and setting the height from the deepest portion to the maximum position of the raised portion within a predetermined range.

### Example 3

A plurality of dots were formed on one surface of the glass substrate in the same manner as in Example 1.

However, in Example 3, the dot had a single ring structure as shown in FIG. 7B.

The ring was a closed loop. The total number of laser irradiation marks included in the closed loop was 12. In addition, the numbers of the average sets and the specific sets were 11 and 1, respectively.

It is to be noted that the diameters of the laser irradiation marks were all set to the same diameter.

After the laser irradiation, the size and shape of the formed dots were measured.

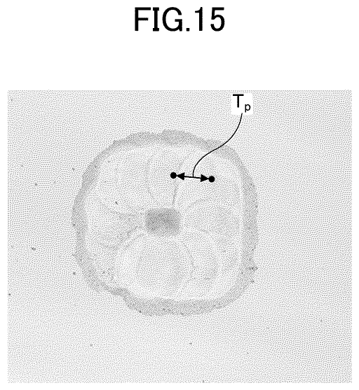

FIG. 15 shows a photograph of the surface of one formed dot. In the average sets, the center-to-center distances between the laser irradiation marks were substantially equal, and Tₐᵥₑ was 12 μm. On the other hand, the center-to-center distance Tₚ of the “specific set” was 20 μm.

In FIG. 15, a line segment indicated by an arrow indicates a center-to-center distance of the “specific set”, that is, Tₚ.

After the laser irradiation, the glass substrate, particularly the dots, were observed, and no abnormalities such as cracks were observed.

In addition, the mark formed on the glass substrate was visually recognized clearly.

TABLE 3 below summarizes the size measurement results of the dots formed in Example 3.

TABLE 3

| | | Maximum | | Number | Average of | Center-to- | | |
|---|---|---|---|---|---|---|---|---|
| | Average | diameter of | Diameter of | of average | center-to- | center | | |
| | diameter of | laser | minimum | set/ | center | distance | | |
| | laser | irradiation | circle | number of | distances of | of specific | | |
| | irradiation | mark ϕₘₐₓ | including | specific | average sets | set Tₚ | Occurrence | Visibility |
| Ex | mark (μm) | (μm) | ring (μm) | set | Tₐᵥₑ (μm) | (μm) | of crack | of dot |
| 3 | 22.5 | 25.0 | 62.1 | 11/1 | 12 | 20 | NO | Excellent |

TABLE 4 below shows the measurement results in the depth direction of the dots in Example 3.

TABLE 4

| | Distance from reference | Distance from reference | Distance from reference | |
|---|---|---|---|---|
| | surface to tip of raised | surface to tip of raised | surface to tip of valley | |
| | portion at outermost | portion at innermost | portion having maximum | Pa + Pd |
| Ex | peripheral portion (μm) | peripheral portion (μm) | depth Pd (μm) | (μm) |
| 3 | 0.10 | 0.10 | 0.35 | 0.45 |

As described above, it was confirmed that even if the specific loop shape of the dot is a closed loop, when the closed loop is formed as in Example 3, the occurrence of cracks is significantly suppressed.

As described above, the light guide plate and the method of manufacturing the light guide plate mask according to the present disclosure have been described. However, the present disclosure is not limited to the above-described embodiments, and the like. Various variations, modifications, substitutions, additions, deletions, and combinations are possible within the scope of claims. They also of course fall within the technical scope of the present disclosure.

What is claimed is:

1. A light guide plate comprising:
a glass substrate having a mark on a surface thereof, wherein
a refractive index of the glass substrate is greater than or equal to 1.7,
the mark is an identifier, an alignment mark, or a combination thereof,
the mark includes a plurality of dots,
each of the dots is contained in a minimum circle having a diameter within a range of 30 μm to 250 μm,
each of the dots has a raised portion higher than the surface of the glass substrate, the raised portion being at an outermost peripheral edge portion and at an innermost peripheral edge portion,
in a cross section orthogonal to the surface of the glass substrate, a height from a deepest portion of each of the dots to a highest position of the raised portion is from 0.11 μm to 4 μm,
each of the dots is composed of an aggregate of laser irradiation marks, each having a diameter of 10 μm to 40 μm, the laser irradiation marks being in contact with or overlapping with adjacent laser irradiation marks,
the laser irradiation marks form at least one loop shape, and
a specific loop shape, which is a loop shape of the at least one loop shape having a diameter of a minimum circle containing the loop shape of less than or equal to 100 μm, is configured as an open loop including an open portion, a length of the open portion being greater than or equal to one tenth of a maximum diameter of the laser irradiation mark and less than or equal to twice the maximum diameter.

2. The light guide plate according to claim 1, wherein
a height of the raised portion from the surface of the glass substrate is greater than 0 μm and less than or equal to 2.0 μm.

3. The light guide plate according to claim 1, wherein
the open loop has at least two open portions.

4. The light guide plate according to claim 1, wherein
the dot has a first loop shape and a second loop shape, the second loop shape surrounding the first loop shape, and the second loop shape being a closed loop shape.

5. The light guide plate according to claim 1, wherein
the glass substrate has a thickness of less than or equal to 1 mm, a surface roughness (root mean square height) Rq of less than or equal to 1 nm, and a parallelism of less than or equal to 10 μm.

6. The light guide plate according to claim 1, wherein
the glass substrate contains at least one of lanthanum (La), titanium (Ti), niobium (Nb), tantalum (Ta), tungsten (W), bismuth (Bi), and tellurium (Te) as a specific element, and
the specific element is contained in a total amount of 1% by mass or more in terms of oxide.

7. The light guide plate according to claim 1, wherein
an average internal transmittance of the glass substrate at a wavelength of 300 nm to 400 nm is less than or equal to 30%.

8. The light guide plate according to claim 1, wherein
the light guide plate is applied to a wearable device capable of virtual reality (VR), augmented reality (AR), and mixed reality (MR).

9. A method of manufacturing a light guide plate comprising:
forming a mark by irradiating a surface of a glass substrate having a refractive index of greater than or equal to 1.7 with laser light, wherein
the laser light has a wavelength in a range of 150 nm to 370 nm,
the mark is an identifier, an alignment mark, or a combination thereof,
the mark includes a plurality of dots,
each of the dots is contained in a minimum circle having a diameter within a range of 30 μm to 250 μm,
each of the dots has a raised portion higher than the surface of the glass substrate, the raised portion being at an outermost peripheral edge portion and at an innermost peripheral edge portion,
in a cross section orthogonal to the surface of the glass substrate, a height from a deepest portion of each of the dots to a highest position of the raised portion is from 0.11 μm to 4 μm,
each of the dots is composed of an aggregate of laser irradiation marks, each having a diameter of 10 μm to 40 μm, the laser irradiation marks being in contact with or overlapping with adjacent laser irradiation marks,
the laser irradiation marks form at least one loop shape,
a specific loop shape, which is a loop shape of the at least one loop shape having a diameter of a minimum circle containing the loop shape of less than or equal to 100 μm, is configured as an open loop including an open portion, a length of the open portion being greater than or equal to one tenth of a maximum diameter of the laser irradiation mark and less than or equal to twice the maximum diameter.

10. The method of manufacturing a light guide plate according to claim 9, wherein
a height of the raised portion from the surface of the glass substrate is greater than 0 μm and less than or equal to 2.0 μm.

11. The method of manufacturing a light guide plate according to claim 9, wherein
the glass substrate has a disk shape.

12. The method of manufacturing a light guide plate according to claim 9, wherein
the glass substrate has a thickness of less than or equal to 1 mm, a surface roughness (root mean square height) Rq of less than or equal to 1 nm, and a parallelism of less than or equal to 10 μm.

13. The method of manufacturing a light guide plate according to claim 9, wherein
the glass substrate contains at least one of lanthanum (La), titanium (Ti), niobium (Nb), tantalum (Ta), tungsten (W), bismuth (Bi), and tellurium (Te) as a specific element, and
the specific element is contained in a total amount of 1% by mass or more in terms of oxide.

14. The method of manufacturing a light guide plate according to claim 9, wherein
an average internal transmittance of the glass substrate at a wavelength of 300 nm to 400 nm is less than or equal to 30%.

15. The method of manufacturing a light guide plate according to claim 9 further comprising:
cutting the glass substrate to obtain a light guide plate of a predetermined size including the mark.

16. A light guide plate comprising:
a glass substrate having a mark on a surface thereof, wherein
a refractive index of the glass substrate is greater than or equal to 1.7,
the mark is an identifier, an alignment mark, or a combination thereof,
the mark includes a plurality of dots,
each of the dots is contained in a minimum circle having a diameter within a range of 30 μm to 250 μm,
each of the dots has a raised portion higher than the surface of the glass substrate, the raised portion being at an outermost peripheral edge portion and at an innermost peripheral edge portion,
in a cross section orthogonal to the surface, a height from a deepest portion of each of the dots to a highest position of the raised portion is from 0.11 μm to 4 μm,
each of the dots is composed of an aggregate of laser irradiation marks, each having a diameter of 10 μm to 40 μm, the laser irradiation marks being in contact with or overlapping with adjacent laser irradiation marks,
the laser irradiation marks form at least one loop shape,
a specific loop shape, which is a loop shape of the at least one loop shape having a diameter of a minimum circle containing the loop shape of less than or equal to 100 μm, is configured as a closed loop,
sets of the laser irradiation marks adjacent to each other include first to n-th sets, an integer n being greater than or equal to 10, and T being a distance between centers of the adjacent laser irradiation marks in each set,
the sets of the laser irradiation marks adjacent to each other include average sets and one or more specific sets,
in each of the average sets, a difference between the distance T and a distance Tₐᵥₑ, which is an average of the distances T in the average sets, is within a range of ±1% of the distance Tₐᵥₑ,
in each of the one or more specific sets, a difference between the distance T and the distance Tₐᵥₑ is outside the range of ±1% of the distance Tₐᵥₑ,
the average sets are, in number, greater than or equal to 90% of all the sets, and
a distance Tₚ between centers of the adjacent laser irradiation marks in each of the one or more specific sets is greater than the distance Tₐᵥₑ by one tenth of a maximum diameter of the laser irradiation mark.
